(19) United States
(12) Patent Application Publication
(10) Pub. No.: US 2008/0126263 A1
(43) Pub. Date: May 29, 2008

(54) Transferable by-catch quotas

(76) Inventor: George Sugihara, Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/716,382

(22) Filed: Mar. 7, 2007

Related U.S. Application Data
(60) Provisional application No. 60/780,268, filed on Mar. 7, 2006.

(51) Int. Cl. G06Q 30/00; G06F 17/00

(52) U.S. Cl. 705/80; 705/10; 705/1; 705/37

(57) ABSTRACT

The present application relates to systems and methods related to by-catch quota. In some embodiments, systems and/or methods relates to distributing, allocating, and/or transferring the quota amongst, for example fishermen. Computer systems may be used to transfer and/or distribute the quota amongst interested parties.

### CROSS-REFERENCE TO RELATED APPLICATIONS

This application claims priority from U.S. application Ser. No. 60/780,268, filed Mar. 7, 2006, which is incorporated herein by reference in its entirety.

### BACKGROUND OF THE INVENTION

1. Field of the Invention

The present application relates to systems and methods for apportioning the quota amongst, for example fishermen, of by-catch unsought-for marine animals.

2. Description of the Related Art

Market economies allocate resources efficiently through setting prices that signal the aggregate demand for a good or a service. Therefore, the demand will be addressed by the motivation of behavior that will lead to production of the good or service. Despite the general success of the market mechanism for such allocation, in some areas traditional markets have not fulfilled their task well. Most notable among these are phenomena in which society wishes to discourage economic activity. The most extreme example of this, of course, is criminal behavior, where the justice system punishes those engage in such behavior.

Unfortunately, the law enforcement model has been extended to address economic behavior that is not in itself criminal, but merely undesirable, and sometimes only undesirable beyond a certain point. The binary “all or none” nature of the criminal model deals poorly with such economic phenomena that intrinsically call for a more graded inhibitory response.

One way to introduce more flexibility into the criminal/regulatory model for undesirable economic activity is to set fines for doing so. Government-imposed financial disincentives can effectively discourage such activity, but themselves have intrinsic disadvantages.

The first concerns determining the magnitude of the fine. Too small a fine may not discourage the activity effectively, as businesses may view the fine as a cost of doing business, and while government may collect revenue from the fines, the activity may continue. Too great a fine may impose a draconian sanction on those running afoul of it so that the line between acceptable and unacceptable economic behavior may instead become a precipice. In addition, even if the fine is set at an appropriate level, over time inflation may render the fine less consequential, necessitating periodic adjustments to achieve the desired inhibitory effect.

The second concerns the relative difficulty of businesses to conform to the regulation. Factors such as the location of a business, the customer market of the business, and the age of the business may determine whether imposed regulations present a herculean task or a simple one, depending on factors that may largely be out of the control of the business.

### SUMMARY OF THE INVENTION

In some embodiments, a method of regulating the capture of a species is provided, including determining a total capture threshold, indicating a total amount of the species that is capturable under a set of regulations; determining a plurality of individual capture quota shares by dividing the total capture threshold into a plurality of individual capture quota shares; allocating the plurality of individual capture quota shares to at least one first party; and providing a transferring device configured to allow transferring of one or more of the plurality of allocated individual capture quota shares from the at least one first party to at least one second party. A plurality of shares may be required to immunize against the capture of a single animal of the species. A single share may immunize against the capture of a plurality of animals of the species. The allocating the plurality of allocated individual capture quota shares may comprise using an electronic device. The transferring may comprise an exchange selected from selling, trading and giving. The set of regulations may comprise regulations selected from government laws, trade union regulations, and market forces. The species may be a marine species. The regulating the capture of a species may comprise regulating the by-catch capture of a species. The plurality of individual capture quota shares may specify a location at which the amount of species is to be captured and/or a time period during which the amount of species is to be captured. The plurality of individual capture quota shares may comprise a percentage of the total capture threshold and/or an absolute number of the species. The allocating the plurality of allocated individual capture quota shares may comprise at least one of: identifying environmental concerns related to the species; identifying the size of the interested party; identifying the business of the interested party; identifying efforts that have been, are being, or will be taken by the interested party to reduce capture of the species; and determining the number of parties interested in the capture of the species.

In some embodiments, a system for regulating the capture of a species is provided, comprising a computer device configured to communicate with at least one quota share supplier and at least one quota share receiver, comprising: a storage device configured to store information related to at least one quota share currently possessed by the at least one quota share supplier, wherein each of the at least one quota shares indicates a total amount of the species that is capturable by a party; an interface module configured to provide the information related to the at least one quota share to the at least one quota share receiver; and a transaction module configured to accept an offer provided by the at least one quota share receiver to purchase one or more of the at least one quota share. The offer provided by the at least one quota share receiver may be a monetary offer of an amount previously specified by the quota share receiver. The transaction module may be configured to allow for offer negotiations between the at least one quota share receiver and the at least one quota share supplier before accepting the offer. The species may be a marine species. The computer device may further comprise a second storage device to store information related to parties interested in receiving at least one quota share; and a distributing module configured to initially distribute a plurality of quota shares amongst the interested parties. A user input may indicate how the distributing module distributes the plurality of quota shares. The system may further include a distribution-calculating module configured to identify a distribution of the plurality of quota shares amongst the interested parties. The interface module may comprise a website.

In some embodiments, a method of distributing quota shares specifying an amount of species that is capturable by a party under a set of regulations is provided, comprising providing, using an electronic device, information related to the quota shares to one or more perspective quota share receivers; identifying, using an electronic device, terms under which a quota share supplier currently possessing a quota share and a perspective quota share receiver agree to the transfer of the quota share; and transferring the quota share from the quota share supplier to the perspective quota share receiver. The species may be a marine species. The terms may comprise a monetary amount that the perspective quota share receiver will provide the quota share supplier in exchange for the quota share.

In some embodiments, a method of regulating the by-catch capture of a marine species is provided, comprising determining a total capture threshold, indicating a total amount of the species that is capturable under a set of regulations; determining a plurality of individual capture quota shares by dividing the total capture threshold into a plurality of individual capture quota shares; allocating the plurality of individual capture quota shares to at least one first party; providing the at least one first party with at least one individual capture quota share; providing an input device by which the at least one first party can input quota share information into a computer system; storing the quota share information; displaying the quota share information to at least one second party; displaying a suggested price for purchasing an individual capture quota share from the at least one first party; and providing an acceptance device by which a second party can agree to pay the suggested price to purchase the individual capture quota share.

In some embodiments, a system for regulating the capture of a species is provided, comprising an input device for receiving quota share information from at least one quota share supplier, wherein the quota share information comprises an amount of species that is capturable under a set of regulations; a storage device for storing the quota share information; a transmitting device for transmitting the quota share information to perspective quota share receivers; and a transaction device for determining a price agreed upon by a perspective quota share receiver and a quota share supplier for the purchasing of the quota share.

In some embodiments, a financial instrument for trading a transferable by-catch quota is provided, comprising an agreement that specifies a species to which the by-catch quota relates; a quantity of that species, expressed in a unit; and a time period to which the quota relates. In some embodiments, the instrument further comprises specifying a price for the financial instrument. The instrument may further comprise specifying a geographic region to which the quota relates. The instrument may further comprise specifying a size of an individual of the species. The species may be selected from the group consisting of fish, mammals, reptiles, amphibians, molluscs, crustaceans, corals, sponges, and birds. The species may be a fish. The species may be selected from the group consisting of Alaska plaice, American shad, arrowtooth flounder, Atka mackerel, boccacio rockfish, butter sole, canary rockfish, Chinook salmon, chum salmon, cod, dab, dark-blotched rockfish, deep-sea sole, dover sole, English sole, flathead sole, flounder, Greenland turbot, haddock, halibut, herring, jack mackerels, juvenile pollock, ling cod, mahi-mahi, northern rockfish, Pacific cod, Pacific mackerel, Pacific Ocean perch, plaice, pollock, red snapper, rex sole, rockfish, rougheye rockfish, sablefish, salmon, sand sole, sharks, shortraker rockfish, sole, starry flounder, swordfish, turbot, wahoo, whiting, widow rockfish, yelloweye rockfish, yellowfin sole, and yellowtail rockfish. The species may be a mammal. The mammal may be selected from the group consisting of dolphins, seals, porpoises, and whales. The mammal may be selected from the group consisting of dolphins, killer whales, humpback whales, steller sea lions, and northern fur seals. The mammal may be a dolphin. The species may be a reptile. The reptile may be a sea turtle. The species may be a mollusc. The mollusc may be selected from the group consisting of squid and octopi. The species may be a crustacean. The crustacean may be selected from the group consisting of lobsters, crabs, and shrimp. The crab may be selected from the group consisting of red king crab, Tanner crab, snow crab, and Dungeness crab. The species may be a bird. The bird may be selected from the group consisting of black-footed albatrosses, laysan albatrosses, and short-tailed albatrosses, petrels, and gulls. The species may be selected from the group consisting of corals and sponges.

In some embodiments, a method for conducting trading of a by-catch quota is provided, comprising specifying a species to which the by-catch quota relates; a quantity of that species, expressed in a unit; and a time period to which the quota relates. The method may further comprise specifying a price. The method may further comprise specifying a geographic region to which the quota relates. The method may further comprise specifying a size of an individual of the species.

In some embodiments, a computer program for trading a by-catch quota is provided, the program comprising instructions for causing the system to receive offering information comprising: a species to which the by-catch quota relates, a quantity of that species, expressed in a unit, and a time period to which the quota relates; enter the offering information into a database; display the offering information to a purchaser, receive purchasing information relating to a purchase by the purchaser; and update the database to reflect the purchase. The offering information may further comprise a price for the quota. The offering information may further comprise information relating to a geographic region to which the quota relates. The offering information may further comprise a size of an individual of the species to which the quota relates.

In some embodiments, a computer-readable medium storing a computer program for trading a by-catch quota is provided, the program comprising instructions for causing the system to: receive offering information relating to a by-catch quota, the information comprising: a species to which the by-catch quota relates, a quantity of that species, expressed in a mutually agreed upon unit, and a time period to which the quota relates; and enter the offering information into a database; display the offering information to a purchaser; receive purchasing information relating to a purchase by the purchaser; and update the database to reflect the purchase. The medium may further comprise specifying a price. The medium may further comprise specifying a geographic region to which the quota relates. The medium may further comprise specifying a size of an individual of the species.

In some embodiments, a system for trading a by-catch quota is provided, comprising a first computer connected to a computer network and having a database for storing information relating to a by-catch quota, the information comprising a species to which the by-catch quota relates, a quantity of that species, expressed in a mutually agreed upon unit, and a time period to which the quota relates; and a second computer connected to the computer network and having a user interface for viewing the information and communicating purchase of the by-catch quota. The information may further comprise a price, a geographical region relating to the quota, and/or a size of an individual of the species.

### BRIEF DESCRIPTION OF THE DRAWINGS

FIG. 1 is a flowchart illustrating a process of regulating the capture of a species.

FIG. 2 is a flowchart illustrating a process of transferring quotas.

FIG. 3 is a block diagram showing an overview of an exemplary computer-implemented system for trading the transferable quotas.

### DETAILED DESCRIPTION OF THE PREFERRED EMBODIMENT

The following detailed description is directed to certain specific embodiments of the invention. However, the invention can be embodied in a multitude of different ways as defined and covered by the claims.

Commercial fishing represents a situation in which traditional market/government regulatory mechanisms have not worked optimally. Fishing, intrinsically a capricious activity, often leads to catching species that are out of season or otherwise protected by the government. For example, because tuna tend to associate with dolphins, tuna fishermen inevitably catch some dolphins, which are protected. Such “by catch” can present a problem to commercial fishermen who may not be able to completely control what they catch. Chance therefore may determine whether they are subject to fines for catching inappropriate species.

Development of technology for reducing by-catch is impeded by the lack of sound pricing information on the costs it now imposes. The “granularity” of historical fine payments by any given fisherman renders the expectation value of fines relatively imprecise. Those seeking to develop technology to address the by-catch problem need to know—and be able to convince skeptical prospective buyers—how much by-catch now costs fishermen industry-wide, so that they can produce and market cost-effective technologies to them.

In some embodiments, systems and methods relate to the introduction of price signals into the by-catch regulatory mechanism. Therefore the accidental take of certain species may be limited, and at the same time a system and/or method may assist a fishermen in determining the real costs of by-catch and building them into their business models.

In one embodiment, methods and systems relate to a financial instrument, termed a “transferable quota,” that allows the bearer to take a specified amount of a species in a given area and a given period (the total allowable take). “Transferable quotas” may be referred to as “quotas”, “by-catch quotas”, or “quota shares”. The transferable quota may regulate the unintentional and/or the intentional capture of a species. Therefore, in some embodiments, the quotas regulate, for example, by-catch capture of a species but in others regulate non-by-catch capture. It will be understood that methods and/or systems may be applied to marine species, such as fish, or to other non-marine species. For example, similar methods may be applied to reduce the killing of a land-born animal.

In some embodiments, quotas may regulate the species caught as by-catch. By-catch species may include not only commercially valuable species that happen to be undersized, out of season, or whose landing is otherwise prohibited at the time they are caught, but also protected non-commercial species. A by-catch species may be one selected from the group consisting of fish, mammals, reptiles, amphibians, molluscs, crustaceans, corals, sponges, and birds.

Examples of by-catch fish include Alaska plaice, American shad, arrowtooth flounder, Atka mackerel, boccacio rockfish, butter sole, canary rockfish, Chinook salmon, chum salmon, cod, dab, dark-blotched rockfish, deep-sea sole, dover sole, English sole, flathead sole, flounder, Greenland turbot, haddock, halibut, herring, jack mackerels, juvenile pollock, ling cod, mahi-mahi, northern rockfish, Pacific cod, Pacific mackerel, Pacific Ocean perch, plaice, pollock, red snapper, rex sole, rockfish, rougheye rockfish, sablefish, salmon, sand sole, sharks, shortraker rockfish, sole, starry flounder, swordfish, turbot, wahoo, whiting, widow rockfish, yelloweye rockfish, yellowfin sole, and yellowtail rockfish.

Mammals too are often caught inadvertently. Examples of by-catch mammals include dolphins, killer whales, humpback whales, steller sea lions, and northern fur seal. Similarly, reptiles, such as sea turtles, molluscs, such as squid and octopi, crustaceans, such as lobsters, shrimp, and crabs (the last including red king crab, Tanner crab, snow crab, and Dungeness crab), corals, sponges, and birds, such as black-footed albatrosses, laysan albatrosses, and short-tailed albatrosses, petrels, and gulls) are all found among bycatch in at least one fishery, and either are now protected or may become so.

A quota may be a physical or a non-physical entity. For example, the quota may be a contact. Alternatively, the quota may be a right to capture an amount of a species. In some embodiments, the transfer of a quota comprises a transfer of a part of the quota. For example, if the quota specifies a specific number of a species that can be captured, a transfer of the quota may comprise transferring the right to capture a portion of that number.

FIG. 1 is a flowchart illustrating a process 100 of regulating the capture of a species. Depending on the embodiment, additional steps may be added, others removed, and the ordering of the steps rearranged.

Starting at a step 101, a total capture threshold is determined. The total capture may indicate the total allowable amount (e.g., by weight, by number of individuals, or by amount of individuals of a given size or age) of a species that can be captured. The species may be a species caught by by-catch capture. It may be restricted to a specific location and/or time period. The total capture threshold may be determined at least in part by government regulations, such as state and/or federal laws. The total capture threshold may be determined at least in part by trade union regulations. The total capture threshold may be determined at least in part by environmental issues. The total capture threshold may be determined at least in part by market forces. For example, the total capture threshold may be increased if the demand for the demand for a product associated with a by-catch is high. The total capture threshold may be determined by a computer-implemented method.

The total capture threshold may be an approximate number. That is, the total capture may be about 400 animals. In some embodiments, the total capture threshold is a number of animals. In some embodiments, the total capture threshold is a weight. In some embodiments, the total capture threshold is a percentage. For example, the total capture threshold may be a threshold on the number of dolphins allowed to be caught relative to the number of tuna caught.

A government regulatory agency may set the total capture threshold. The total capture threshold may also be set by another agency or mechanism, e.g., voluntary agreement.

At a step 103 of process 100, an individual capture quota share is determined. The individual capture quota shares may be certificates or otherwise denominated shares (physical or electronic) that specify the share of the total capture threshold take that the bearer is allowed to take. The quota shares may be specific to a particular location and/or time period. In a preferred embodiment, the individual capture quota share is denominated as a percentage of the total capture threshold, but in other embodiments, the individual capture quota share could be denominated on an absolute basis e.g., the number of individuals or the weight of the given species of a given age or size that can be captured. Quota shares may be denominated so that multiple shares (say 1000) may be required to immunize against taking a single by-catch individual. Alternatively, the individual capture quota shares may denominate the number of by-catch relative to the total number of marine animals caught. The individual capture quota shares may denominate the number of by-catch relative to a number of another marine species caught. They may denominate the percentage from a single catch, over multiple catches, or over multiple catches within a given time period. The individual capture quota shares may be determined by a computer-implemented method.

At step 105 of process 100, transferable quotas are allocated to one or more parties. The quota may be provided to the one or more parties via an electronic system. The electronic system may comprise a computer. Alternatively, the quota may be provided non-electronically, such as through the mail.

In some embodiments, individual capture quota shares may be purchased from an agency or party using graduated payments. Therefore, the price may, for example, exponentially increase with the size of the initial allocations.

Methods for allocating individual capture quota shares can vary. Their unit size and allocation (that is, the share of the total capture threshold) can be determined by a variety of methods. For example, in one embodiment, individual capture quota shares have a finite life span (e.g. 1-10 years) and can be annually or semi-annually auctioned (e.g., in public forum or open only to stakeholders, fisheries council/association members, electronically using the internet and/or using an electronic market place or exchange, or some combination thereof). This would allow the market to determine their value. To discourage monopoly, a graduated internal quota tax can be implemented by the fisheries council, the proceeds of which are then re-distributed in equal shares to all members of the fisheries association or by some other equitable formula (e.g., equal distribution per viable fishing boat). Alternatively, there may be an upper allowable limit on the amount of quota that can be accumulated by a single entity. In an example of which the capture quota limits the number of a marine animal captured, annual expirations on the quota shares could allow fishermen to decide for themselves the likely quotas they would need for the upcoming fishing season. On the other hand, it may be more desirable in some fisheries for the individual capture quota shares to become a permanent property right, in which case they can be allocated by some specified method (e.g. auction, or by governmental decree) and subsequently traded.

As an alternative method to allocation of individual capture quota shares by auction, a council (e.g., a fisheries council) may allocate capture quota shares according to the expectation value of capture (e.g., by-catch) for the prospective bearer i.e. the fishing capacity of entities. For example, the individual capture quota shares may increase with the size of the fishing fleet, and/or the size of the boat(s) involved. In other embodiments, the capture quota shares may be allocated by a fisheries council (or other governing body) according to the recent catch history of the fishermen desiring such quotas, or some combination of the above.

A method may use other factors to determine the individual capture quota shares. For example, more quota may preferentially be distributed to fisheries that employ methods or technologies to reduce by-catch.

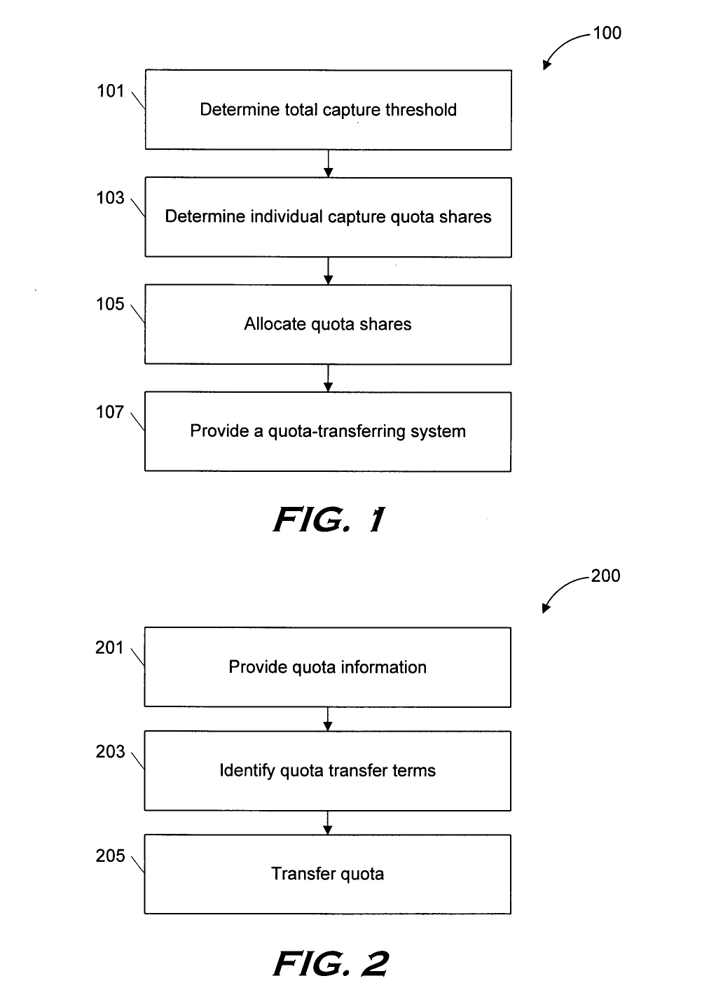

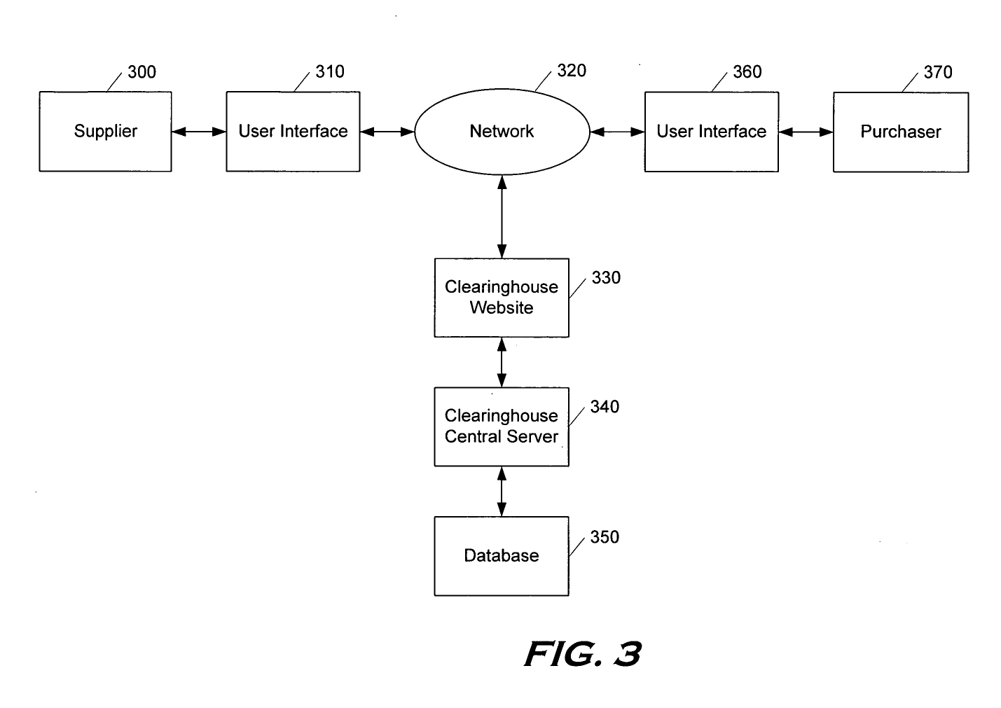

At step 107 of process 100, a quota-transferring system is provided. The quota-transferring system may be an electronic system. The transferable quotas can be traded using the quota-transferring system. An exemplary quota-transferring system is described with reference to FIG. 2 and FIG. 3. Parties who have inadvertently (or advertently) exceeded their quota could purchase additional quota shares from other parties who do not happen to need their entire allocation of quota shares. In some embodiments, environmental groups may purchase quota shares. The value of such transferable quotas may be set by market forces, which in this case may include such factors as: 1) the commercial value of the by-catch species, 2) the value of the target species (e.g., the value of a by-catch quota may move in tandem with the value of the target species), 3) the effort required to harvest the target species (low effort required when target stocks are abundant), 4) the proximity of the expiration date of the quota shares (quota price should fall as the expiration date approaches), 5) the proximity to the total capture limit (e.g., how close the fishery is to exceeding the aggregate by-catch capture limit. Periods in which the total capture of a given species approaches the assigned limit may cause the value of the transferable quotas to increase, and conversely.

A quota system or method described herein may be enforced in a variety of ways. In some embodiments, an agency provides representatives to monitor the catch of fishing boats. For example, a representative may be required to be present on each fishing expedition of one or more fisheries. The fishing agency may be, for example, the National Marine Fisheries Services.

In another aspect, methods and/or systems are related to trading such transferable quotas. In a one embodiment, the system is a computer-implemented system.

FIG. 2 is a flowchart illustrating a process 200 of regulating the capture of a species. Depending on the embodiment, additional steps may be added, others removed, and the ordering of the steps rearranged. In some embodiments, a system may perform one or more of the steps of process 200. The system may be a computer-implemented system. In some embodiments, process 200 relates to structures of FIG. 3.

Starting at step 201, quota information is provided. The information in the form of contract specification, quota bid/offer price and quantity may be provided to the exchange (or clearing house in FIG. 3), by the quota buyer and seller respectively. Alternatively the quota contracts may have specifications that are standardized by the exchange. Quota information may include among other things the specification of terms and restrictions such as location and time period to which the quota applies, the species to which it applies, the expiration date of the contract, the identity of the buyer/seller, and/or the quantity of by-catch immunized by each quota share, where the quantity as above can be specified by the number of individuals, and/or weight volume. It will be understood that although a certain number of quota shares may have initially been allocated to the quota supplier, the quota supplier may then sell or trade quota as needed to immunize the by-catch accrued or anticipated in any given period of time (e.g., individual cruise or fishing season).

Prospective buyers and sellers may provide information about the quota contracts being sought or offered using an input device that connects prospective buyers and sellers through an exchange that logs and displays this information electronically via a communications network such as the internet. For example, the input device may be a keyboard, rollerball, pen and stylus, mouse, or voice recognition system.

The input device may also be a touch screen associated with an output device. The user may respond to prompts on the display by touching the screen. Textual or graphic information may be entered by the user through the input device.

At step 203 of process 200, quota transfer terms are identified. In preferred embodiments, the transfer terms indicate the specific quantity and price asked by sellers of quota, and the specific quantity and price bid by buyers of quota. Optionally, the buyer/seller or exchange may indicate other relevant information regarding the quota, such as the geographical area or fishing period to which it pertains. In some embodiments, an agency or a third party may regulate the price of the quota. The agency or third party may consider factors such as market supply and demand, environmental issues, and/or quota information in the price setting. A set of instructions may determine the price of the quota. Instructions may refer to computer-implemented steps for processing information in the system. Instructions can be implemented in software, firmware or hardware and may include any type of programmed step undertaken by components of the system. In some embodiments, a buyer or a purchaser may accept the seller's price for the transferable quota shares. The buyer may view the quota information through a user interface. The information may be transmitted through a network, as described in greater detail in FIG. 3. In some embodiments, a buyer may submit a bid for quota shares. Once seller and buyer agree upon a price, the buyer may provide the seller with cash or other agreed-upon consideration. In one embodiment, the buyer can purchase the transferable quota with cash or other financial instrument, but payment could also be made in kind. In one embodiment, as a bilateral transaction, the buyer may provide the seller directly with cash via an online monetary transaction. In another embodiment, as an exchange mediated transaction, the quota may be purchased from the seller and sold to the buyer by the exchange who accepts the transaction risk of the transfer of quota shares.

At step 205 of process 200, the quota is transferred. In some embodiments, the quota is an electronic entity, and the transferring of the quota comprises reassigning the quota to the buyer on an electronic system or electronic exchange which maintains a database or ledger of bids and offers and transacted trades of quota shares. In some embodiments, a physical quota certificate or contract is sent to the buyer. In some embodiments, an electronic quota certificate or contract is sent to the buyer. In some embodiments, an electronic exchange is notified of the transfer, and the exchange may complete the transfer.

In some embodiments, transferable quotas are offered and/or purchased through use of a system involving a computer. The system may comprise one or more modules. As can be appreciated by one of ordinary skill in the art, each of the modules may comprise various sub-routines, procedures, definitional statements, and macros. Each of the modules are typically separately compiled and linked into a single executable program. Therefore, the following description of each of the modules may be used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware.

One or more buyers/sellers may transmit information relevant to offered transferable quotas to a central server, which can maintain a database or ledger of transferable quotas on offer. Referring to FIG. 3, supplier 300 uses a conventional user interface 310 to access, via a network such as the Internet 320 clearinghouse website 330 where supplier 300 enters information relating to a transferable quota. The conventional user interface 310 may include input devices, such as those described above. The network may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, the network includes network variations such as the public Internet, a private network within the Internet, a secure network within the Internet, a private network, a public network, a value-added network, an intranet, and the like.

A system described herein may therefore include an Internet Protocol (IP). Internet Protocol (IP) is a network layer protocol used by many corporations, governments, and the Internet worldwide. IP network layer supports many personal, technical and business applications, such as electronic mail, electronic fund transfers, medical records processing and similar data transfers. IP is a connectionless network layer protocol that performs addressing, routing and control functions for transmitting and receiving datagrams over a network. The network layer routes packets from source to destination. An IP datagram is a data packet comprising a header part and a data part. The header part includes a fixed-length header segment and a variable-length optional segment. The data part includes the information being transmitted over the network. As a connectionless protocol, IP does not require a predefined path associated with a logical network connection. Hence, IP does not control data path usage. If a network device or line becomes unavailable, IP provides the mechanism needed to route datagrams around the affected area.

The information entered is transmitted from website 330 to clearinghouse central server 340 which records the information in database 350. The database may comprise memory. Memory refers to electronic circuitry that allows information, typically computer data, to be stored and retrieved. Memory can refer to external devices or systems, for example, disk drives or tape drives. Memory can also refer to fast semiconductor storage (chips), for example, Random Access Memory (RAM) or various forms of Read Only Memory (ROM), which are directly connected to the processor. Other types of memory include bubble memory and core memory.

Server 340 transmits information from database 350 to website 330 which transmit the information over Internet 320 to a conventional user interface 360 for viewing by buyer 170. Website 330 can list information concerning the offered transferable quotas such as the identity of the species, the quantity of the species to which the quota pertains, and optionally the geographic area, period, and price of the offered quota. Website 330 may further provide information regarding the supplier 300. The web pages are virtual documents that each has embedded links which link portions of the virtual pages to other virtual pages and other data. A user can traverse the virtual pages and download data by selecting with a mouse or other input device a predetermined portion of the virtual page.

Purchaser 370 can use a conventional user interface 360 to enter his purchase order, which is then transmitted via network 320 such as the Internet, to the central server 340 via website 330. Central server 340 can receive the purchaser's transaction information, verify the purchaser's identity and financial bona fides and then can update database 350 and website 330 to reflect the purchaser's transaction. The central server then optionally sends a communication to supplier 300 to indicate purchaser's 370 acceptance of the offered transferable quota.

In one embodiment a system is provided for trading transferable quotas on a species, comprising a first computer connected to a computer network, such as the Internet, and having a database for storing information relating to a transferable quota. Such information may include the identity of the species, the quantity of species to which the quota pertains, and optionally the geographic area, period, and price of the offered quota. The system may further comprise a second computer connected to the computer network and having a user interface for viewing and communicating acceptance of the transferable quota.

In some embodiments, communications taking place over the Internet or other network are encrypted for security, as is commonly done with financial transactions.

In some embodiments, quotas are initially distributed using a computer system. For example, information related to various fishing businesses may be entered using a first computer. The information may be stored on a database. In some embodiments, another party may view the stored information using a second computer and may determine the distribution of quotas. In other embodiments, a computer-implemented method processes the information and determines the distribution of quotas. In some embodiments, the distribution of the quotas is transmitted over the network and displayed on the first computers of the fishing businesses. The information may include the total distribution of the quotas or may only indicate the number of quota assigned to a given fishing business.

Use of transferable quotas may change the dynamics of fishing, especially commercial fishing. By removing the incentive to catch as many fish as quickly as possible, often in poor weather, and to land them as expeditiously as possible, often injuring them in the process, transferable quotas may increase the safety of fishing and minimize the handling damage to the fish caught.

### EXAMPLE

By-catch quota associated with a first species (e.g., dolphins) protected by by-catch limits are distributed among various businesses by a government agency. At least one of the businesses considers selling some of the by-catch quota for the first species. A representative of the business (e.g., the supplier) provides information related to the by-catch quota on a website.

A second business, intends to fish for a second species (e.g., tuna) in an area where the second fish species are found in especially close proximity to the first species (e.g., dolphins).

A representative of the second business views the website and determines that the supplier is offering by-catch quota for the first species and that the quota allows the bearer the right to take a certain number of the first species in a specified area over a specified fishing season.

The representative of the second business enters their bid at a terminal that transmits the bid to a database on a central clearinghouse server that displays the offer on the clearinghouse's website. Subsequently, the second business learns that their bid is accepted. The clearinghouse's server updates the database and the website to reflect the purchase of the quota.

The second business later begins fishing, and realizes that despite the extensive intermingling of the second species with the first species, their recently acquired fishing technology has, as hoped, significantly reduced their by-catch of the first species. The representative of the second business navigates again to the website on the clearinghouse's server and enters information relating to the unneeded transferable by-catch quota that the second business wishes to offer for purchase. As before, the information includes the species to which the quota refers, and the allowable by-catch conferred by ownership of the quota, as well as optional information concerning, the price, geographical area, and fishing period. The second business finds that the market price for its quota is higher than its original purchase price because other fishermen, not having adopted the same technology, are catching the first species at a greater than anticipated rate. The second business later having sold its transferable by-catch quota for the first species, can then determine on a objective basis whether acquiring its new fishing technology made an economic and financial sense by comparing the cost of the technology with gain or loss associated with the transferable by-catch quota.

The above example refers to trading transferable by-catch quotas on the spot, or current market, for more or less immediate use. Implicit in the use of transferable by-catch quotas as disclosed here, however, is the option to trade futures on them, that is, to trade the right to buy and sell transferable by-catch quotas for use at some future date. Such trading can be effected through a computer-mediated system like that described above.

The above description is by way of illustration only and is not intended to be limiting in any respect. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within the scope.

What is claimed is:

1. A method of regulating the capture of a species, comprising:
determining a total capture threshold, indicating a total amount of the species that is capturable under a set of regulations;
determining a plurality of individual capture quota shares by dividing the total capture threshold into a plurality of individual capture quota shares;
allocating the plurality of individual capture quota shares to at least one first party; and
providing a transferring device configured to allow transferring of one or more of the plurality of allocated individual capture quota shares from the at least one first party to at least one second party.

2. The method of claim 1, wherein the allocating the plurality of allocated individual capture quota shares comprises using an electronic device.

3. The method of claim 1, wherein a plurality of shares are required to immunize against the capture of a single animal of the species.

4. The method of claim 1, wherein a single share immunizes against the capture of a plurality of animals of the species.

5. The method of claim 1, wherein the transferring comprises an exchange selected from selling, trading and giving.

6. The method of claim 1, wherein the set of regulations comprises regulations selected from government laws, trade union regulations, and market forces.

7. The method of claim 1, wherein the species is a marine species.

8. The method of claim 1, wherein the regulating the capture of a species is regulating the by-catch capture of a species.

9. The method of claim 1, wherein the plurality of individual capture quota shares specifies a location at which the amount of species is to be captured.

10. The method of claim 1, wherein the plurality of individual capture quota shares specifies a time period during which the amount of species is to be captured.

11. The method of claim 1, wherein the plurality of individual capture quota shares comprises a percentage of the total capture threshold.

12. The method of claim 1, wherein the plurality of individual capture quota shares comprises an absolute number of the species.

13. The method of claim 1, wherein the allocating the plurality of allocated individual capture quota shares comprises at least one of: identifying environmental concerns related to the species; identifying the size of the interested party; identifying the business of the interested party; identifying efforts that have been, are being, or will be taken by the interested party to reduce capture of the species; and determining the number of parties interested in the capture of the species.

14. A system for regulating the capture of a species, comprising a computer device configured to communicate with at least one quota share supplier and at least one quota share receiver, comprising:
a storage device configured to store information related to at least one quota share currently possessed by the at least one quota share supplier, wherein each of the at least one quota shares indicates a total amount of the species that is capturable by a party;
an interface module configured to provide the information related to the at least one quota share to the at least one quota share receiver; and
a transaction module configured to accept an offer provided by the at least one quota share receiver to purchase one or more of the at least one quota share.

15. The system of claim 14, wherein the offer provided by the at least one quota share receiver is a monetary offer of an amount previously specified by the quota share receiver.

16. The system of claim 14, wherein the transaction module is configured to allow for offer negotiations between the at least one quota share receiver and the at least one quota share supplier before accepting the offer.

17. The system of claim 14, wherein the species is a marine species.

18. The system of claim 14, wherein the computer device further comprises:
a second storage device to store information related to parties interested in receiving at least one quota share; and
a distributing module configured to initially distribute a plurality of quota shares amongst the interested parties.

19. The system of claim 18, wherein a user input indicates how the distributing module distributes the plurality of quota shares.

20. The system of claim 18, further comprising a distribution-calculating module configured to identify a distribution of the plurality of quota shares amongst the interested parties.

21. The system of claim 14, wherein the interface module comprises a website.

22. A method of distributing quota shares specifying an amount of species that is capturable by a party under a set of regulations, comprising:
providing, using an electronic device, information related to the quota shares to one or more perspective quota share receivers;
identifying, using an electronic device, terms under which a quota share supplier currently possessing a quota share and a perspective quota share receiver agree to the transfer of the quota share; and
transferring the quota share from the quota share supplier to the perspective quota share receiver.

23. The method of claim 18, wherein the species is a marine species.

24. The method of claim 18, wherein the terms comprise a monetary amount that the perspective quota share receiver will provide the quota share supplier in exchange for the quota share.

25. A method of regulating the by-catch capture of a marine species, comprising:
determining a total capture threshold, indicating a total amount of the species that is capturable under a set of regulations;
determining a plurality of individual capture quota shares by dividing the total capture threshold into a plurality of individual capture quota shares;
allocating the plurality of individual capture quota shares to at least one first party;
providing the at least one first party with at least one individual capture quota share;
providing an input device by which the at least one first party can input quota share information into a computer system;
storing the quota share information;
displaying the quota share information to at least one second party;
displaying a suggested price for purchasing an individual capture quota share from the at least one first party; and
providing an acceptance device by which a second party can agree to pay the suggested price to purchase the individual capture quota share.

26. A system for regulating the capture of a species, comprising:
an input device for receiving quota share information from at least one quota share supplier, wherein the quota share information comprises an amount of species that is capturable under a set of regulations;
a storage device for storing the quota share information;
a transmitting device for transmitting the quota share information to perspective quota share receivers; and
a transaction device for determining a price agreed upon by a perspective quota share receiver and a quota share supplier for the purchasing of the quota share.

27. A financial instrument for trading a transferable by-catch quota, comprising an agreement that specifies:
a species to which the by-catch quota relates;
a quantity of that species, expressed in a unit; and
a time period to which the quota relates.

28. The instrument of claim 27, further comprising specifying a price for the financial instrument.

29. The instrument of claim 27, further comprising specifying a geographic region to which the quota relates.

30. The instrument of claim 27, further comprising specifying a size of an individual of the species.

31. The instrument of claim 27, wherein the species is selected from the group consisting of fish, mammals, reptiles, amphibians, molluscs, crustaceans, corals, sponges, and birds.

32. The instrument of claim 31, wherein the species is a fish.

33. The instrument of claim 32, wherein the species is selected from the group consisting of Alaska plaice, American shad, arrowtooth flounder, Atka mackerel, boccacio rockfish, butter sole, canary rockfish, Chinook salmon, chum salmon, cod, dab, dark-blotched rockfish, deep-sea sole, dover sole, English sole, flathead sole, flounder, Greenland turbot, haddock, halibut, herring, jack mackerels, juvenile pollock, ling cod, mahi-mahi, northern rockfish, Pacific cod, Pacific mackerel, Pacific Ocean perch, plaice, pollock, red snapper, rex sole, rockfish, rougheye rockfish, sablefish, salmon, sand sole, sharks, shortraker rockfish, sole, starry flounder, swordfish, turbot, wahoo, whiting, widow rockfish, yelloweye rockfish, yellowfin sole, and yellowtail rockfish.

34. The instrument of claim 31, wherein the species is a mammal.

35. The instrument of claim 34, wherein the mammal is selected from the group consisting of dolphins, seals, porpoises, and whales.

36. The instrument of claim 35, wherein the mammal is selected from the group consisting of dolphins, killer whales, humpback whales, steller sea lions, and northern fur seals.

37. The instrument of claim 35, wherein the mammal is a dolphin.

38. The instrument of claim 31, wherein the species is a reptile.

39. The instrument of claim 38, wherein the reptile is a sea turtle.

40. The instrument of claim 31, wherein the species is a mollusc.

41. The instrument of claim 40, wherein the mollusc is selected from the group consisting of squid and octopi.

42. The instrument of claim 31, wherein the species is a crustacean.

43. The instrument of claim 42, wherein the crustacean is selected from the group consisting of lobsters, crabs, and shrimp.

44. The instrument of claim 43, wherein the crab is selected from the group consisting of red king crab, Tanner crab, snow crab, and Dungeness crab.

45. The instrument of claim 31, wherein the species is a bird.

46. The instrument of claim 45, wherein the bird is selected from the group consisting of black-footed albatrosses, laysan albatrosses, and short-tailed albatrosses, petrels, and gulls.

47. The instrument of claim 31, wherein the species is selected from the group consisting of corals and sponges.

48. A method for conducting trading of a by-catch quota, comprising specifying
a species to which the by-catch quota relates;
a quantity of that species, expressed in a unit; and
a time period to which the quota relates.

49. The method of claim 48, further comprising specifying a price.

50. The method of claim 48, further comprising specifying a geographic region to which the quota relates.

51. The method of claim 48, further comprising specifying a size of an individual of the species.

52. A computer program for trading a by-catch quota, the program comprising instructions for causing the system to:
receive offering information comprising:
a species to which the by-catch quota relates,
a quantity of that species, expressed in a unit, and
a time period to which the quota relates;
enter the offering information into a database;
display the offering information to a purchaser, receive purchasing information relating to a purchase by the purchaser; and
update the database to reflect the purchase.

53. The program of claim 52, wherein the offering information further comprises a price for the quota.

54. The program of claim 52, wherein the offering information further comprises information relating to a geographic region to which the quota relates.

55. The program of claim 52, wherein the offering information further comprises a size of an individual of the species to which the quota relates.

56. A computer-readable medium storing a computer program for trading a by-catch quota, the program comprising instructions for causing the system to:
receive offering information relating to a by-catch quota, the information comprising:
a species to which the by-catch quota relates,
a quantity of that species, expressed in a mutually agreed upon unit, and
a time period to which the quota relates; and
enter the offering information into a database;
display the offering information to a purchaser;
receive purchasing information relating to a purchase by the purchaser; and
update the database to reflect the purchase.

57. The medium of claim 56, further comprising specifying a price.

58. The medium of claim 56, further comprising specifying a geographic region to which the quota relates.

59. The medium of claim 56, further comprising specifying a size of an individual of the species.

60. A system for trading a by-catch quota, comprising:
a first computer connected to a computer network and having a database for storing information relating to a by-catch quota, the information comprising:
a species to which the by-catch quota relates,
a quantity of that species, expressed in a mutually agreed upon unit, and
a time period to which the quota relates; and
a second computer connected to the computer network and having a user interface for viewing the information and communicating purchase of the by-catch quota.

61. The system of claim 60, the information further comprising a price.

62. The system of claim 60, the information further comprising a geographical region relating to the quota.

63. The system of claim 60, further comprising a size of an individual of the species.
